(19) United States
(12) Patent Application Publication
(10) Pub. No.: US 2004/0170187 A1
(43) Pub. Date: Sep. 2, 2004

(54) Symbol buffer memory device of a base station modem in a mobile communication system and storage method for using the sevice

(76) Inventor: Dae-Whan Back, Seoul (KR)

Correspondence Address: Peter L. Kendall, Roylance, Abrams, Berdo & Goodman, L.L.P., Suite 600, 1300 19th Street, N.W., Washington, DC, 20036, US

(21) Appl. No.: 10/784,170

(22) Filed: Feb. 24, 2004

(30) Foreign Application Priority Data
Feb. 28, 2003 (KR) 2003-12782

(51) Int. Cl. H04L 12/28

(52) U.S. Cl. 370/412

(57) ABSTRACT

A symbol buffer memory device and method of a base station modem in a mobile communication system, in which the symbol data corresponding to at least one logical channel and coded in at least one encoding ratio is stored for transmission of the symbol data to a physical layer. The symbol buffer memory device and method employ a buffer memory for storing the symbol data for the logical channel according to input sequences so that the symbol data between logical channels are stored in a continuous arrangement; a start address table for storing address information according to the logical channels, each of the address information indicating a location of initial symbol data corresponding to each of the logical channels from among the symbol data stored in the buffer memory; and a multiplexer for selectively outputting the address information stored in the start address table by an enable signal set for each of the logical channels.

This application claims priority to an application entitled “Symbol buffer memory device of a base station modem in a mobile communication system and storage method using the device” filed in the Korean Industrial Property Office on Feb. 28, 2003 and assigned Ser. No. 2003-12782, the contents of which are incorporated herein by reference.

### BACKGROUND OF THE INVENTION

1. Field of the Invention

The present invention relates to a mobile communication system, and more particularly to a symbol buffer memory device of a base station modem in a mobile communication system and a storage method for using the device, in which the symbol data corresponding to at least one logical channel and coded in at least one encoding ratio is stored in the symbol buffer memory device for transmission of the symbol data to a physical layer.

2. Description of the Related Art

In a base station modem of conventional mobile communication systems, a buffer memory is segmented into a minimum amount of processing units and managed and operated by the minimum amount of processing units, in order to enable processing of symbol data coded from a plurality of channels having different transmission speeds.

Also, the size of a symbol buffer memory used by a base station modem is determined by the size of the maximum channel data which can be transferred. Traditional symbol data processors determine the maximum number of channels and the size of the buffer memory capable of processing the channel data.

Because data transmission speed of each channel may be variable, the buffer memory is divided into segments of a predetermined size in order to support transmission speeds of all channels and the divided segments have different table addresses. Thus, buffers are assigned while the addresses are managed and linked with each other in the described manner.

Hereinafter, as described above, a conventional data processing structure for a symbol buffer memory will be explained with reference to FIG. 1.

As described in FIG. 1, the data processing structure of the symbol buffer memory includes a Logical Address Table (LAT) 120, a first multiplexer 130, a Physical Address Table (PAT) 140, a second multiplexer 150, a buffer memory 160, a channel selection unit 100, a third multiplexer 110. The LAT stores a logical address of each segment updated by a Digital Signal Processor (DSP). The first multiplexer 130 multiplexes and outputs addresses stored by the LAT in order to select a specific address. The PAT 140 stores actual physical addresses of the buffer memory. The second multiplexer 150 receives an address from among the addresses stored by the PAT 140, which is selected by the first multiplexer 130 as a selection signal and outputs the selected physical address. The buffer memory 160 receives the physical address output from the second multiplexer 150 and outputs symbol data stored in a segment corresponding to the physical address. The channel selection unit 100 and the third multiplexer 110 produce a selection signal which enables the output of a logical address according to a channel to be operated, which is selected from among a plurality channels.

Hereinafter, a process of recording and reading the symbol data by means of the data processing structure of the symbol buffer memory 160 will be described.

First, in recording, symbol data encoded by a frame of a predetermined size are input into the buffer memory 160 under the control of an administrative DSP. The symbol data are obtained after data corresponding to each channel are encoded according to a predetermined transmission speed. Also, the symbol data of each channel input to the buffer memory 160 are input while forming a frame. Accordingly, the symbol data corresponding to a plurality of channels are recorded and read by the frame in the buffer memory 160.

In other words, if the symbol data forming a frame are input to the buffer memory 160, they are stored in each segment of the buffer memory 160 according to channels under the control of the administrative DSP. For instance, first, if symbol data of a channel ‘0’ are input to the buffer memory 160, the symbol data are sequentially stored in a first segment of the buffer memory 160. Second, if symbol data of a channel ‘2’ are input to the buffer memory 160, the symbol data are sequentially stored in a second segment of the buffer memory 160. If other symbol data have already been recorded on the second segment to be stored, the symbol data will be stored in the next available segment, a third segment.

Meanwhile, while the symbol data of each channel are stored in the buffer memory, if the data to be recorded have a size exceeding a segment, the data are recorded again from the initial word of the next segment. In other words, it is possible that at least two segments may be allocated for one channel. In this situation, link information between two segments is marked on the last sector of the previous segment in the buffer memory 160 or in the LAT 120 so that the symbol data recorded in the next segment can be also read after all symbol data recorded in previous segments have been read.

When the symbol data for each channel are recorded on the buffer memory 160, the administrative DSP changes the corresponding channel value of the channel selection unit 100 from ‘disable’ to ‘enable’ and records a logical address of the corresponding channel in the LAT 120. Thus, the administrative DSP records that the symbol data of the corresponding channel have been stored in the buffer memory 160.

Also, when the symbol data of the corresponding channel are recorded in the buffer 160, a physical address of the segment in which the corresponding symbol data are being recorded is recorded in the PAT 140 via a hardware operation.

Therefore, when the symbol data information is stored by the frame in the buffer memory 160, information in relation to segments that store the symbol data is recorded and updated according to channels in the channel selection unit 100, the LAT 120, and the PAT 160. For instance, when symbol data of a channel ‘0’ are stored in a first segment sector of the buffer memory 160, information corresponding to the channel ‘0’ of the channel selection unit 100 is updated from ‘disable’ to ‘enable’, a physical address of the first segment is mapped with channel ‘0’ of the PAT 140 and stored in the PAT 140, and a logical address corresponding to the physical address is mapped with the channel ‘0’ of the LAT 120 and is stored in the LAT 120.

Whenever information about a next channel is stored, values in the table are continuously stored and updated. When all channel symbol data of a frame have been completely stored, the stored data are transmitted to a physical layer processor.

Meanwhile, if the symbol data of the channel ‘0’ have a size exceeding the first segment, the excess portion of the symbol data are written in another segment on which data are not recorded. Also, as described, since the separately-recorded symbol data of the channel ‘0’ are data for the same channel, link information between the segments on which the symbol data are recorded must be stored. Even when the symbol data of the channel ‘0’ are stored only in a portion of the first segment, symbol data of other channels are not recorded in the other portion of the first segment. In other words, if symbol data of a channel ‘2’ following the symbol data of the channel ‘0’ are input, the symbol data of the channel ‘2’ are not recorded in the remaining sector of the first segment, but are recorded in an initial sector of a second segment which has not been recorded. Also, physical and logical addresses of the second segment in which the symbol data are recorded are stored in the PAT 140 and the LAT 120, and information corresponding to the channel ‘2’ of the selection unit 100 is updated to ‘enable’.

Hereafter, a process of reading and transmitting the symbol data stored in the buffer memory 160 to the physical layer processor will be described with reference to FIG. 1.

First, if a channel pulse signal 170 is input to the third multiplexer 110 as a control signal for the third multiplexer 110, the third multiplexer 110 sequentially outputs selection signals for channels according to activation states of each channel (‘enable’ or ‘disable’) stored in the channel selection unit 100. The channel pulse signal 170 provides sequentially generated pulses corresponding to all channels from channel ‘0’ to channel ‘n’. Also, when a pulse signal corresponding to a predetermined channel of the channel pulse signal 170 is input, the corresponding channel information is scanned from a table of the channel selection unit 100.

For instance, if a pulse signal corresponding to channel ‘0’ of the channel pulse signal 170 is input as a control signal of the multiplexer 110, information corresponding to the channel ‘0’ is scanned from the table of the channel selection unit 100 according to the input signal. As a result of the scanning, if the information corresponding to the channel ‘0’ is in the ‘enable’ state, a selection signal corresponding to the channel ‘0’ is output though the multiplexer 110. If the information corresponding to the channel ‘0’ is in the ‘disable’ state, the selection signal is not output and a next channel pulse signal 170 is input as a control signal for the multiplexer 110.

A selection signal corresponding to a predetermined channel output from the third multiplexer 170 is input as a control signal for the first multiplexer 130. The first multiplexer 130 outputs a logical address of a predetermined channel in the LAT 120 according to the selection signal corresponding to the predetermined channel. When symbol data corresponding to the predetermined channel are stored in the buffer memory 160, the logical address includes logical address information mapped to a physical address of a corresponding segment in which the symbol data are stored.

For instance, when a control signal for the channel ‘0’ is input to the first multiplexer 130 as a control signal for the first multiplexer 130, the first multiplexer 130 searches and outputs a logical address corresponding to the channel ‘0’ of the LAT 120.

The logical address for the corresponding channel, which is output from the first multiplexer 130, is input as a control signal for the second multiplexer 150, and the input control signal enables output of a physical address for the corresponding channel of the PAT 140.

For instance, when a logical address corresponding to the channel ‘0’ is input to the second multiplexer 150 as a control signal of the second multiplexer 150, the second multiplexer 150 searches and outputs a physical address corresponding to the channel ‘0’ of the PAT 140.

Then, symbol data stored in a segment of the buffer memory 160 corresponding to the physical address output from the second multiplexer 150 are read by means of the physical address.

In other words, if symbol data corresponding to the channel ‘0’ are stored in a first segment sector of the buffer memory 160, a selection signal corresponding to the channel ‘0’ is output from the channel selection unit 100 according to channel information of ‘enable’ state, a logical address corresponding to the channel ‘0’ stored in the LAT 120 is output by the selection signal, and a physical address indicating a specific segment sector of the buffer memory 160 storing the symbol data corresponding the channel ‘0’ is output from the PAT 140 by the logical address. Symbol data are read from the specific segment sector corresponding to the physical address in the buffer memory 160. After all of the symbol data stored in the specific segment sector corresponding to the physical address are read, when link information for another segment exists (e.g. address information for a linked segment), that is, when symbol data are separately stored in different segments, symbol data stored in the linked segment are continuously read.

As described, because information of the linked segment is stored in the last sector of the buffer memory 160, if the link information is read after reading symbol data stored in the segment, symbol data are continuously read from the linked segment with reference to the link information.

Otherwise, the link information may be stored in the LAT 120. In this case, a logical address corresponding to a predetermined channel may be output from the LAT 120, so that data can be read from a segment corresponding to a physical address mapped with the logical address. When the reading has been completed, another logical address corresponding to the same channel as the first logical address, which is linked with the first logical address, is output. Thus, symbol data stored in a segment corresponding to a physical address mapped with another logical address are additionally read. Here, the additionally-read symbol data corresponding to the same channel as the symbol data of the initial segment are symbol data which are sequentially linked with each other when initially recorded.

Meanwhile, as described above, when it is necessary to reset or change values set according to channels in the LAT 120 and the channel selection unit 100, the DSP records the values. In contrast, values in the PAT are automatically recorded via a hardware configuration. Each of the two tables (the LAT and the PAT) has a plurality of divided segments in order to support a plurality of channels, and the LAT 120 has different tables each of which corresponds to a segment. The PAT 140 is stored by the hardware itself. That is to say, the hardware stores physical addresses of an actual buffer memory so that the logical address of the selected channel can be mapped with the corresponding physical address.

Also, as a method of linking channels, the LAT 120 may have logical addresses connected with each other by means of a linked-list in order to indicate all data of a channel selected by the channel selection unit 100 and the third multiplexer 110. Therefore, each address of the LAT 120 is linked with an address of a next segment to be used. A channel number indicating a first segment becomes the first logical address. The first logical address is recorded by the administrative DSP when the channel is initially installed. When the installed channel service is provided at a maximum transmission speed and data of the installed channel cannot be contained in one segment, the data are divided and then stored in different segments. Therefore, the number of segments is larger than or at least equal to the number of channels

First, the channel selection unit 100 having confirmed set of a channel selects a logical address for the set channel (that is, a logical address of a corresponding segment) and searches a corresponding physical address of the buffer memory from the PAT 140 using the logical address. Contents of the buffer memory can be read by means of the physical address obtained in this manner. If the amount of data to be transferred is larger than one segment, a linked-list of the LAT 120 is traced to find a logical address of a next segment.

Accordingly, the described configuration in which a buffer memory is segmented and administrated complicates the design of the hardware and also increases the size of the hardware. In other words, in order to administrate a plurality of channels which may have different processing speeds, the conventional symbol buffer memory in a base station modem requires a logical address table, a multiplexer corresponding to the logical address table, a physical address table, and a multiplexer corresponding to the physical address table. The logical address table is used to segment and administrate the buffer memory and is employed for a logic, which is provided for determining whether channels are installed or not during the calculation of a buffer memory address by the logical address value with reference to a substantial buffer memory address table. The multiplexer for the logical address table selects a logical address from the logical address table. The physical address table stores each physical address corresponding to each logical address. The multiplexer for the physical address table selects a physical address from the physical address table. Therefore, the conventional symbol buffer memory complicates the design of the hardware and also increases the size of the hardware.

### SUMMARY OF THE INVENTION

Accordingly, the present invention has been made to solve the above- mentioned problems occurring in the prior art, and an object of the present invention is to provide a symbol buffer memory device of a base station modem in a mobile communication system and a storage method for using the device, in which symbol data transferred from an administrative DSP are continuously stored instead of being stored in a plurality of segments divided according to channels in the buffer memory, so that the symbol data can be efficiently stored.

It is another object of the present invention to provide a symbol buffer memory device of a base station modem in a mobile communication system and a storage method for using the device, which can efficiently store and manage symbol data output after an administrative DSP conducts symbol level processing for a plurality of channels having different processing speeds, especially in a base station modem of a Universal Mobile Telecommunication System (UMTS) which is a next generation mobile communication system.

It is another object of the present invention to provide a symbol buffer memory device of a base station modem in a mobile communication system and a storage method for using the device, which facilitate recording and reading of symbol data stored in a buffer memory, which are transferred from an administrative DSP, thereby reducing the complexity and size of the hardware of the entire system.

In order to substantially accomplish these objects, a symbol buffer memory device of a base station modem in a mobile communication system is provided, in which the symbol data corresponding to at least one logical channel and coded in at least one encoding ratio is stored for transmission of the symbol data to a physical layer, the symbol buffer memory device comprises a buffer memory for storing the symbol data for the logical channel according to input sequences so that the symbol data between logical channels are continuously arrayed; a start address table for storing address information according to the logical channels, each of the address information indicating a location of initial symbol data corresponding to each of the logical channels from among the symbol data stored in the buffer memory; and a multiplexer for selectively outputting the address information stored in the start address table by an enable signal set for each of the logical channels.

In accordance with another aspect of the present invention, a method of storing symbol data in a symbol buffer memory device of a base station modem in a mobile communication system is provided, in which the symbol data corresponding to at least one logical channel and coded in at least one encoding ratio is stored in the symbol buffer memory device for transmission of the symbol data to a physical layer, the method comprises: storing the symbol data for the logical channel according to input sequences in a buffer memory so that the symbol data between logical channels are continuously arrayed; storing address information according to the logical channels in a start address table, each of the address information indicating a location of initial symbol data corresponding to each of the logical channels from among the symbol data stored in the buffer memory; and selectively outputting the address information stored in the start address table by an enable signal set for each of the logical channels.

When storage of symbols corresponding to a predetermined logical channel has been completed, an initial symbol of a logical channel is subsequently stored at a position of a word in the buffer memory next to the already-stored symbols.

It is preferred that a selection signal input to the multiplexer is produced by reading an enable state of a corresponding channel by means of a pulse signal of each channel, the enable state of the corresponding channel being stored in the start address table.

Also, when symbol data for one channel are divided and stored in at least two storage sectors of the buffer memory, link information between the storage sectors in which the symbol data for said one channel are stored is stored in the buffer memory.

When symbol data for one channel are divided and stored in at least two storage sectors of the buffer memory, link information between the storage sectors in which the symbol data for said one channel are stored is stored in the start address table.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a conventional buffer memory device;

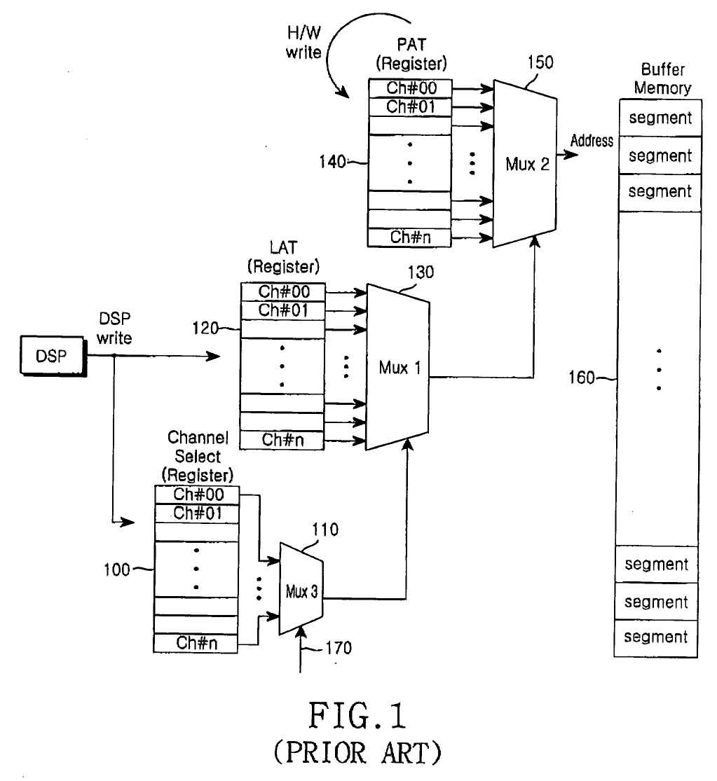

FIG. 2 is a block diagram illustrating a symbol buffer memory device according to the embodiment of the present invention;

FIG. 3 is a flow chart illustrating a process of storing data by means of a symbol buffer memory device according to the embodiment of the present invention; and

FIG. 4 is a flow chart illustrating a process of reading data by means of a symbol buffer memory device according to the embodiment of the present invention.

### DETAILED DESCRIPTION OF THE PREFERRED EMBODIMENT

An embodiment of the present invention will be described in detail with reference to the accompanying drawings. Note that the same or similar components in drawings are designated by the same reference numerals. In the following description of the present invention, a detailed description of known functions and configurations incorporated herein will be omitted for conciseness.

The embodiment of the present invention provides for storing symbol data of a channel in a buffer memory via an administrative DSP even when symbol data having different data lengths and coded at different speeds according to each channel are processed. Also, next channel symbol data are recorded in a sector of the buffer memory next to the sector in which the previous symbol data have been recorded. Therefore, the recording can be continuously performed without dividing the segments.

In other words, in a conventional buffer memory included in a base station modem in a mobile communication system as described in the background section, storage sectors are segmented, the segments are then assigned to channels, and symbol data are stored according to the segments. However, in a symbol buffer memory device according to the embodiment of the present invention, symbol data corresponding to a plurality of channels can be continuously stored according to data sizes of the channels. Therefore, the embodiment of the present invention can maximize the storage efficiency of the buffer memory.

Moreover, the conventional buffer memory employs a complicated design having multiplexers and registers, each storing a plurality of tables, in order to perform reading and recording in the buffer memory. In contrast, one register and one multiplexer in a symbol buffer memory device according to the embodiment of the resent invention can produce the same result as the conventional buffer memory.

The embodiment of the present invention includes start symbol addresses, each of which indicates an address of a position at which start symbol data of each channel are stored in the buffer memory, must be stored so as to differentiate the stored symbol data according to channels. Therefore, when the symbol data are read, the start symbol addresses stored according to the channels enable the symbol data to be differentiated from each other according to the channels.

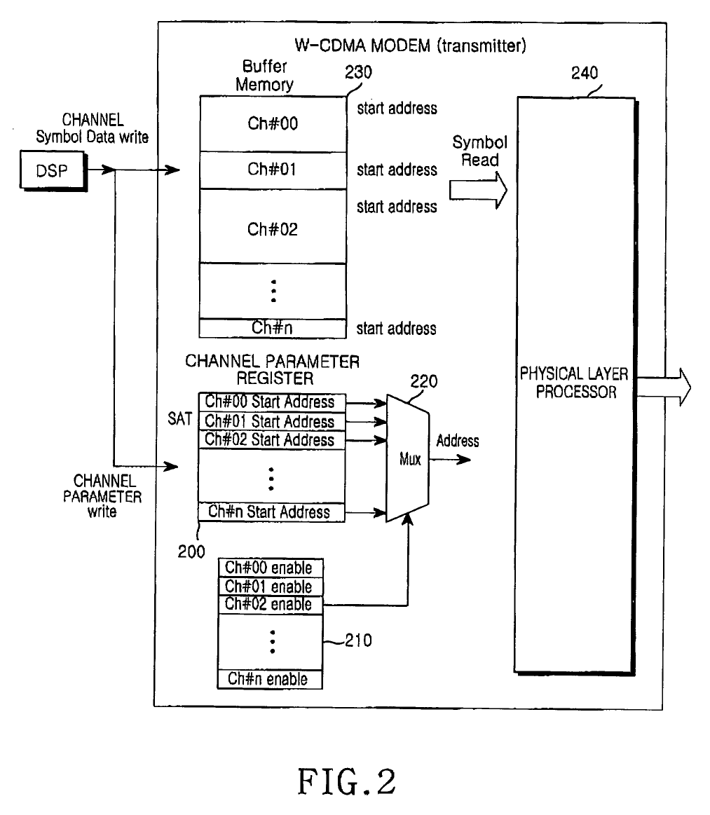

Hereinafter, a structure of a symbol buffer memory device according to embodiment of the present invention will be described with reference to FIG. 2.

As shown in FIG. 2, the embodiment of the present invention employs a start address table 200, a multiplexer 220, a channel selection unit 210, and a buffer memory 230. The start address table 200 stores start addresses of the buffer memory 230 which stores symbol data of corresponding channels. The multiplexer 220 selects a stored start address and outputs it to the buffer memory 230 when the corresponding channel is operated. The channel selection unit 210 stores state values ‘enable’, which represent whether the channels are operated or not. The buffer memory 230 can simultaneously store the symbol data of channels processed by the administrative DSP without division of segments.

Specifically, a symbol buffer memory according to the embodiment of the present invention includes the buffer memory 230, the start address table 200, and the multiplexer 220. The buffer memory 230 stores symbol data corresponding to one or more logical channels according to a sequence in which the data are input, so that the symbol data between the logical channels are arranged in series. The start address table 200 stores pieces of address information according to the logical channels, each piece of the address information indicating a location of initial symbol data from among the symbol data stored in the buffer memory 230. The multiplexer 220 selectively outputs physical address information corresponding to the initial symbol data of each logical channel stored in the start address table 200 according to an enable signal of each logical channel recorded on a table of the channel selection unit 210.

As shown in FIG. 2, a symbol buffer memory according to the embodiment of the present invention has a much simpler structure and can perform recording and reading in the buffer memory 230 more simply, in comparison with the conventional method of storing symbol data of each channel in divided segments.

Hereinafter, a process of reading and recording data according to the embodiment of the present invention will be briefly described with reference to FIG. 2.

The administrative DSP records symbol data corresponding to a first channel on the buffer memory 230 from among a plurality of channels which will be serviced at different speeds. Thereafter, the administrative DSP records symbol data of a next channel on a word next to the word on which the symbol data of the first channel have been recorded. In the same manner, the DSP records symbol data of all channels having been set in the buffer memory 230. When the symbol data are written by the above method, the recorded data for different channels have different sizes according to speeds of the channels. Further, the administrative DSP records start address values for symbol data according to the channels in the start address table 200, the start address values having been recorded in the buffer memory 230. Then, in the base station modem unit for performing downlink processing, the channel selection unit 210 determines whether a corresponding channel operates or not, and the multiplexer 220 selects a start address indicating the starting point of symbol data of the corresponding channel. The start address is sent to the buffer memory 230 so that the symbol data of the corresponding channel are read from the initial position of the data corresponding to the desired channel. The other channels can be processed in the same way and method as described above.

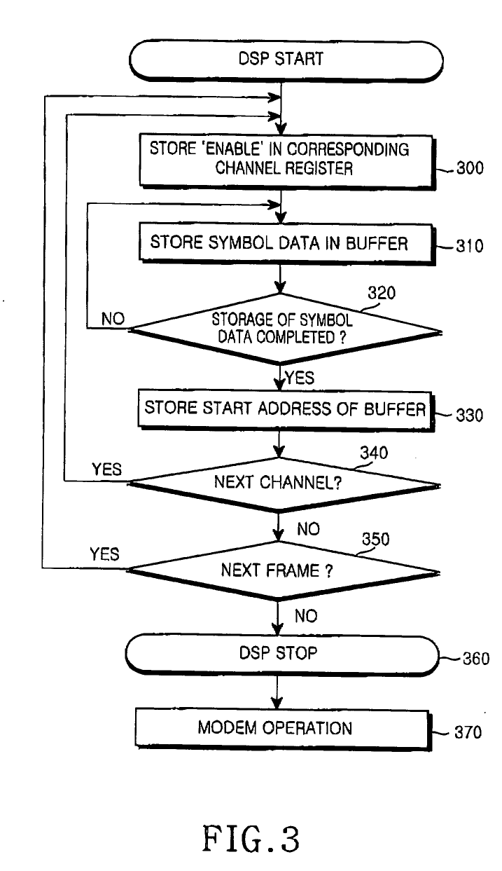

Hereinafter, a mechanism for recording symbol data on a symbol buffer memory 230 according to the embodiment of the present invention will be described in more detail with reference to FIGS. 2 and 3.

First, the administrative DSP starts an operation, so that coded symbol data are input by the frame having a predetermined size to the buffer memory 230 according to control by the administrative DSP. The symbol data includes symbols obtained by encoding data corresponding to each channel according to a predetermined transmission speed. The symbol data of each channel are input to the buffer memory 230 while forming a frame. Therefore, in the buffer memory 230, the symbol data corresponding to a plurality of channels are recorded and read by the frame.

As described above, when the symbol data forming a frame are input to the buffer memory 230, the symbol data are stored in a storage sector of the buffer memory 230 according to channels under the control of the administrative DSP in a sequence in which the data are input. For instance, first, if symbol data corresponding to a channel ‘0’ are input, a channel register value of the channel ‘0’ is updated from the ‘disable’ state to the ‘enable’ state on a table of the channel selection unit 210 (step 300). The symbol data of the channel ‘0’ are sequentially recorded from the first storage sector of the buffer memory 230 (step 310). Next, if symbol data corresponding to a channel ‘2’ are input, a channel register value of the channel ‘2’ is updated from the ‘enable’ state to the ‘disable’ state. Input symbol data of channel ‘2’ are stored in a word next to the word in which the last symbol data of channel ‘0’ have been stored, and the other symbol data of the channel ‘2’ are continuously stored thereafter.

Meanwhile, when symbol data of one channel are recorded in the buffer memory 230 as described, the administrative DSP changes a corresponding channel value stored in a table of the channel selection unit 210 from the ‘disable’ state to the ‘enable’ state in order to record that the symbol data of the corresponding channel have been recorded in the buffer memory 230. Further, when all the symbol data of one channel have been completely recorded in the buffer memory 230 (step 320), physical address information indicating a position at which the first symbol data of the channel are recorded is stored in the start address table 200 (step 330).

The process of storing the physical address information can be conducted either when the first symbol data of one channel have been stored or when all symbol data of one channel have been stored as described above.

Thus, when symbol data information is stored in the buffer memory 230 by the frame, address information indicating positions at each of which the first symbol data of each channel are recorded is stored in the start address table 200. Therefore, the symbol data of each channel can be easily read.

When storage of all symbol data for said one channel has been completed, storage of data for a next channel is conducted in the same manner as described (step 340). When there exists no channel next to the input frame, that is to say, when storage of symbol data for all channels of the frame has been completed, a data input procedure for a next frame is performed. Also, when storage of data for all frames has been completed, the operation of the administrative DSP ends (step 360), and a modem operates in order to output the stored symbol data (step 370).

A symbol buffer memory device according to the embodiment of the present invention is different from the conventional buffer memory in that symbol data are not recorded according to channels by the segment when the symbol data are stored in the buffer memory 230, so that difference between transmission speeds and data lengths of the channels do not result in problems. In the conventional buffer memory, symbol data for each channel are assigned by the segment, there may exist extra or redundant buffer sectors due to a difference between the size of each segment and the size of the symbol data corresponding to each channel. However, in a symbol buffer memory device according to the embodiment of the present invention, symbol data for different channels are continuously stored, so as to not generate extra or redundant buffer sectors, thereby enabling the buffer memory to be used efficiently.

In other words, storage of data according to segments may result in inefficient use of sectors with no record thereon in the conventional buffer memory. However, in a symbol buffer memory device according to the embodiment of the present invention, initial symbol data of a next channel is recorded subsequently to the last word of the last symbol data of a previous channel, so that efficiency in use of the buffer memory 230 can be maximized.

Meanwhile, if a storage sector of the buffer memory 230 in which recorded data already exists is detected while the symbol data of a predetermined channel are being recorded, the symbol data are continuously recorded in a first unrecorded storage sector after the recorded storage sector. Meanwhile, since symbol data of the same channel are separately recorded in different sectors, link information must be stored so that last symbol data of a previous storage sector and first symbol data of a next storage sector can be subsequently read.

The link information may be stored in the same manner as that in the prior art. In other words, when last symbol data of a previous storage sector are recorded in the buffer memory 230, address information indicating the position at which first symbol data of a next storage sector are recorded can be marked at the last portion of the previous storage sector.

Otherwise, the link information may be stored in the start address table 200. In other words, when the symbol data of the predetermined channel may be separately stored in different sectors, link information between an initial physical address of an anterior storage sector in which an anterior portion of the symbol data is stored and an initial physical address of a posterior storage sector in which a posterior portion of the symbol data may be stored in the start address table 200, so that the anterior and posterior portions of the symbol data separately stored in different storage sectors can be continuously read.

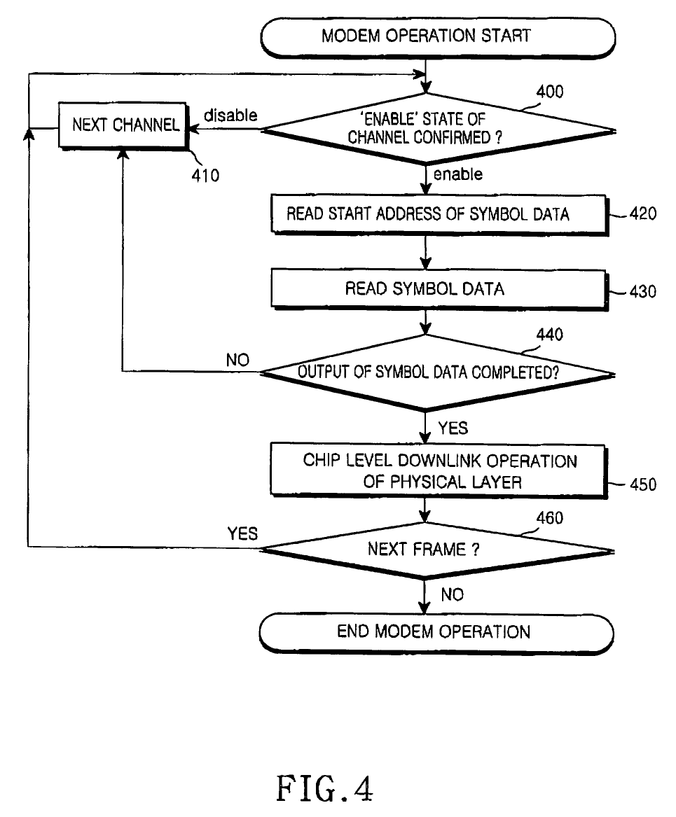

Hereinafter, a process of reading symbol data stored in the symbol buffer memory 230 according to the embodiment of the present invention will be described with reference to FIGS. 2 and 4.

First, if data of the channel selection unit 210 are scanned by the channel pulse signal (not shown), selection signals of channels are sequentially output according to activation states (that is, ‘enable’ or ‘disable’) of the channels stored in the channel selection unit 210 (step 400). The channel pulse signal has pulses corresponding to all channels from channel ‘0’ to channel ‘n’, which are sequentially generated. If a channel pulse signal corresponding to a predetermined channel is input, information of a corresponding channel is scanned from a table of the channel selection unit 210.

For instance, if a channel pulse signal corresponding to channel ‘0’ is input to the channel selection unit 210, information of the channel ‘0’ is scanned from a table of the channel selection unit 210. As a result of the scan, if the information corresponding to the channel ‘0’ indicates an ‘enable’ state, the selection signal of the channel ‘0’ is output to the multiplexer 220. If the information corresponding to the channel ‘0’ indicates a ‘disable’ sate, the selection signal as described above is not output and a next channel pulse signal is input to the channel selection unit 210.

A selection signal for a predetermined channel output from the channel selection unit 210 is input as a control signal for the multiplexer 220. The multiplexer 220 outputs a start address value on the buffer memory 230 of the corresponding channel from the start address table 200 according to the selection signal of the predetermined channel (step 420). When symbol data of the corresponding channel are stored in the buffer memory 230, the start address value represents a physical address information indicating a position at which the first symbol data of the corresponding channel are stored.

For instance, when a control signal corresponding to channel ‘0’ is input to the multiplexer 220 as a control signal, the multiplexer 220 having received the control signal searches and outputs a start address value of channel ‘0’ (that is to say, a physical address indicating a position at which the first symbol data of the corresponding channel are stored) from the start address table 200.

Symbol data stored at a position corresponding to a start address of the buffer memory 230 are read by means of the start address value ultimately output from the multiplexer 220.

In other words, if symbol data of the channel ‘0’ are recorded from a location ‘FFFFH’ of the buffer memory 230, a selection signal for the channel ‘0’ is output from state information ‘enable’ of the channel ‘0’ of the channel selection unit, and the start address value (that is, ‘FFFFH’) of the channel ‘0’ stored in the start address table is output by the selection signal.

The symbol data of the corresponding channel are sequentially read from a position of the buffer memory 230 corresponding to the output start address (step 430). When the symbol data of the corresponding channel are read, if there is link information for another sector (e.g., a linked start address information), that is, if the symbol data of the corresponding channel are separately stored in different sectors, the symbol data stored in the linked sector are continuously read.

As described above, the information of the linked sector is stored in the last part of the first sector of the buffer memory 230 in which the symbol data of the corresponding channel are stored. After the symbol data have been read from the first sector, the link information (e.g., a start address of a next sector ) is read, and then the symbol data are continuously read from the linked sector with reference to the read link information.

According to another method, in which the linked information is stored in the start address table 200, a start address value corresponding to a predetermined channel is output from the start address table 200, and symbol data are read from a position of the buffer memory 230 corresponding to the start address. When reading of the symbol data has been completed, another start address value corresponding to the same channel as the previous start address and linked to the previous start address is output from the start address table 200, so that symbol data are read from a position of the buffer memory 230 corresponding to said another start address. The additionally-read symbol data correspond to the same channel as the symbol data of the first sector and are sequentially linked with the symbol data of the first sector when initially recorded.

Also, when a channel is newly set or changed as described above, the administrative DSP records a set value for each channel of the start address table 200 and the channel selection unit 210. The start address table 200 can be divided into sectors corresponding to channels in order to support the multiple channels. Also, the start address table 200 stores physical address values which can indicate positions of the first symbol data of each channel by a selection signal of a selected channel.

Furthermore, according to another method for linking channels to each other, the start address table 200 may have start address values with a linked list which indicates all channels selected by the channel selection unit 210. Therefore, each value of the start address table 200 is linked with an address value of a next sector in which data are stored after being divided. A channel number given to a first sector becomes a first start address value. The first start address value can be recorded by the administrative DSP either when a corresponding channel is initially set or after the corresponding channel is completely recorded.

Meanwhile, when reading of the symbol data of the corresponding channel has been completed (step 430), a process of reading a next channel is repeated in the same manner as described above (step 410). When symbol data corresponding to all channels of a corresponding frame have been completely output (step 440), a physical layer processor 240 performs a downlink operation to a chip level (step 450).

Also, when the above-mentioned process for a predetermined frame has been completed, a process of reading a next frame is repeated in the same manner as described.

Finally, if symbol data for all frames have been read, operation of the modem ends.

In the embodiment of the present invention, the buffer memory 230 may be realized by two memories including a first memory and a second memory for more efficient operation. Accordingly, symbol data of all channels corresponding to a predetermined frame are first recorded in the first memory, and all symbol data corresponding to a frame input next to the predetermined frame are recorded in the second memory. Here, the symbol data stored in the first memory may be read simultaneously when the symbol data of the next input frame are stored in the second memory. Likewise, simultaneously when the symbol data stored in the second memory are read, symbol data of a next frame may be stored in the first memory from which the previously stored symbol data have been already read.

Therefore, the embodiment of the present invention enables the buffer memory 230 to simultaneously perform reading and recording of continuously input multiple frame data in real time.

In a symbol buffer memory device according to the embodiment of the present invention as described above, the DSP operation can be realized with a start address table replacing a logical address table, and a buffer memory is operated as a buffer pool without being segmented. Thus, a symbol buffer memory device according to the embodiment of the present invention includes a control logic, tables, multiplexers, and so forth, with simplified structures, so that total hardware size can be reduced.

Further, in a symbol buffer memory device according to the embodiment of the present invention as described above, symbol data of a next channel are recorded from a position directly after symbol data of a previous channel are recorded, so that the symbol data of all the channel of the buffer memory can be processed only with a start address table. Therefore, the embodiment of the present invention can improve the efficiency of the buffer, and can reduce the size of the buffer memory while enabling the buffer memory to process an increased amount of data.

While the invention has been shown and described with reference to a certain embodiment thereof, it will be understood by those skilled in the art that various changes in form and details may be made therein without departing from the spirit and scope of the invention. Consequently, the scope of the invention should not be limited to the described embodiment, but should be defined by the appended claims and equivalents thereof.

What is claimed is:

1. A symbol buffer memory device of a base station modem in a mobile communication system, in which the symbol data corresponding to at least one logical channel and coded in at least one encoding ratio is stored for transmission of the symbol data to a physical layer, the symbol buffer memory device comprising:
a buffer memory for storing the symbol data for the logical channel according to input sequences so that the symbol data between logical channels are stored in a continuous arrangement;
a start address table for storing address information according to the logical channels, each of the address information indicating a location of initial symbol data corresponding to each of the logical channels from among the symbol data stored in the buffer memory; and
a multiplexer for selectively outputting the address information stored in the start address table by an enable signal set for each of the logical channels.

2. The symbol buffer memory device as claimed in claim 1, wherein, when storage of symbols corresponding to a predetermined logical channel has been completed, an initial symbol of a logical channel is subsequently stored at a position of a word in the buffer memory next to the already-stored symbols.

3. The symbol buffer memory device as claimed in claim 1, wherein a selection signal input to the multiplexer is produced by reading an enable state of a corresponding channel by means of a pulse signal of each channel, the enable state of the corresponding channel being stored in the start address table.

4. The symbol buffer memory device as claimed in claim 1, wherein, when symbol data for one channel are divided and stored in at least two storage sectors of the buffer memory, link information between the storage sectors in which the symbol data for said one channel are stored is stored in the buffer memory.

5. The symbol buffer memory device as claimed in claim 1, wherein, when symbol data for one channel are divided and stored in at least two storage sectors of the buffer memory, link information between the storage sectors in which the symbol data for said one channel are stored is stored in the start address table.

6. A method of storing symbol data in a symbol buffer memory device of a base station modem in a mobile communication system, in which the symbol data corresponding to at least one logical channel and coded in at least one encoding ratio is stored in the symbol buffer memory device for transmission of the symbol data to a physical layer, the method comprising the steps of:
storing the symbol data for the logical channel according to input sequences in a buffer memory so that the symbol data between logical channels are stored in a continuous arrangement;
storing address information according to the logical channels in a start address table, each of the address information indicating a location of initial symbol data corresponding to each of the logical channels from among the symbol data stored in the buffer memory; and
selectively outputting the address information stored in the start address table by an enable signal set for each of the logical channels.

7. The method as claimed in claim 6, wherein, when storage of symbols corresponding to a predetermined logical channel has been completed, an initial symbol of a logical channel is subsequently stored at a position of a word in the buffer memory next to the already-stored symbols.

8. The method as claimed in claim 6, wherein a selection signal input to the multiplexer is produced by reading an enable state of a corresponding channel by means of a pulse signal of each channel, the enable state of the corresponding channel being stored in the start address table.

9. The method as claimed in claim 6, wherein, when symbol data for one channel are divided and stored in at least two storage sectors of the buffer memory, link information between the storage sectors in which the symbol data for said one channel are stored is stored in the buffer memory.

10. The method as claimed in claim 6, wherein, when symbol data for one channel are divided and stored in at least two storage sectors of the buffer memory, link information between the storage sectors in which the symbol data for said one channel are stored is stored in the start address table.
